(19) United States
(12) Patent Application Publication
(10) Pub. No.: US 2013/0147621 A1
(43) Pub. Date: Jun. 13, 2013

(54) SYSTEMS AND METHODS FOR ASSISTING FIREFIGHTERS DURING A FIRE DRILL BY IDENTIFYING LOCATIONS OF VICTIMS, EXITS, AND DANGEROUS AREAS

(71) Applicant: Yat Wai Edwin Kwong, Causeway Bay (HK)

(72) Inventor: Yat Wai Edwin Kwong, Causeway Bay (HK)

(21) Appl. No.: 13/323,635

(22) Filed: Dec. 12, 2011

(51) Int. Cl. G08B 19/00

(52) U.S. Cl. 340/521

(57) ABSTRACT

Systems and methods for helping a firefighter to identify locations of victim, routes of egress, and dangerous areas during a fire drill are provided. The system's components include a fire jacket, a fire goggle, a communications device with earpiece, a locator, a compass, a temperature sensor, a smoke sensor, a processor and memory. Also provided is a life saving device with locator associated with each of one or more victims. The temperature and smoke sensors are disposed within a building in which the fire drill is to be executed. The memory stores instructions that cause the processor to execute a method that guides a firefighter to a victim and/or exit along the safest and most direct route possible. The route being determined based on feedback from the sensors as well as real-time location data from the locators.

### FIELD OF THE INVENTION

This invention is generally related to training in preparation of fire drills. More specifically, this invention is related to training firefighters in order to help them identify locations of victim, exits and dangerous areas.

### BACKGROUND OF THE INVENTION

Numerous types of equipment have been provided to firefighters. Such equipment usually entails special garments intended to withstand the very high temperatures that are usually encountered during a real fire. Occasionally, firefighters may sometimes be present at the scene of a fire for an extended period of time. Thus, numerous developments have been made regarding equipment or tools that can provide oxygen to the firefighter for extended periods of time. Moreover, in order to reduce firefighters' time inside buildings with burning fires, numerous communications systems have been introduced.

However, none of these communications systems are sophisticated enough to facilitate a firefighter to make educated and informed decisions as to how to proceed through a building to rescue victims. None of these systems provide instructions to a firefighter in view of the floor plan that is currently being traversed by the firefighter. Moreover, none of these systems have been customized to assess real-time conditions of the particular building that is experiencing a fire drill.

In view of the foregoing, there is a need for novel systems and methods of facilitating a faster and safer means for a firefighter to locate victims and bring them to safety during a fire drill.

### SUMMARY OF THE INVENTION

According to embodiments of the invention, a system for helping a firefighter to identify dangerous areas, locations of victim, and routes of egress during a fire drill is provided. The system's components include a fire jacket, a fire goggle, a communications device with earpiece, a locator, a compass, a temperature sensor, a smoke sensor, a processor and memory. Also provided is a life saving device associated with each of one or more victims. Each of the life saving devices includes a locator for locating each of the victims. The temperature and smoke sensors are disposed within a building in which the fire drill is to be executed. There may be more than one of each so as to cover all of the important hallways and passages throughout the building. The memory comprises instructions that cause the processor to execute a method.

The method comprises the following the following steps. The first step involves detecting that a firefighter has put on the fire goggle, so that the fire drill is initiated. The second step involves detecting the location of a victim, wherein the detection is based on the life saving device that the victim is wearing. The next step involves determining a direct route between the firefighter and the victim. Then, an assessment is made as to whether the direct route is dangerous. The assessment is based on a number of factors. The factors include the average temperature and average amount of smoke along the direct route, as measured by the temperature and smoke sensors, respectively. If, based on the assessment, it is determined that the direct route is dangerous, then a safer indirect route is calculated in consideration of the average temperature and amount of smoke along the indirect route. For the purpose of this specification and claims, the route which is chosen to be the safest, regardless of whether it is the direct or indirect route, will be considered the target route.

Upon determining a target route, the firefighter is guided to advance along the route until the victim is reached. Upon reaching the victim, an assessment is made as to whether the direct exit route is dangerous. The assessment is based upon the same factors which were assessed with regard to the ingress route to find the victim. Once again, based on the assessment of average temperature and amount of smoke it is determined if the direct exit route is dangerous. If the direct exit route is found to be dangerous, an indirect route is calculated which takes into account the temperature and amount of smoke. Upon determination of the indirect route, the firefighter is guided along the target exit route.

In a further embodiment of the disclosed invention, the guiding of the firefighter along the target route entails periodically alerting the firefighter regarding distance and time until the victim and/or exit is reached. It also entails checking whether the current path being taken is correct, and alerts the firefighter as to the correct path if the current one is incorrect.

In still a further embodiment of the disclosed invention, the guiding involves digitally displaying the target route on the lens of firefighter's goggles. Furthermore, the alerting of the firefighter may be carried out via voice commands transmitted through the firefighter's earpiece. Finally, an additional step may be provided of using the compassing device to detect whether the firefighters procession along the target route is correct.

In another embodiment of the disclosed technology, a method for helping a firefighter to identify dangerous areas, locations of victims, and routes of egress during a fire drill is provided. The method begins by providing a fire jacket to a firefighter. The fire jacket has an associated fire goggle, a communicator with earpiece, a locator and a compass. Next, a plurality of potential victims is provided a life saving device. Each life saving device has a locator. The locator may use GPS or some other wireless system to enable detection of location accurate to within a few feet. Next, one or more temperature and smoke sensors are installed throughout a building. The building to be the location where the fire drill will occur and where the victims are located. The method proceeds when the fire jacket is initiated or powered on upon detection that the jacket has been equipped or vested by the firefighter. Next, the location of the victim or victims is determined by detecting the locator of the victim's life saving device. Upon detection, a target route is calculated to the pinpointed location of the victim. The calculation of the target route takes into account data received from the temperature and smoke sensors in order to calculate the safest, yet most direct route to the victim. Then, the firefighter is guided to the victim along the target route. Once the victim is discovered, an exit route is calculated. Once again, the calculation incorporates data from the temperature and smoke sensors in order to determine the shortest, least dangerous path to the exit along the exit route.

In further variations of this embodiment, the guiding of the firefighter along the target route entails periodically alerting the firefighter regarding distance and time until the victim and/or exit is reached. It also entails checking whether the current path being taken is correct, and alerts the firefighter as to the correct path if the current one is incorrect.

In still further variations of this embodiment, the guiding involves digitally displaying the target route on the lens of firefighter's goggles. Furthermore, the alerting of the firefighter may be carried out via voice commands transmitted through the firefighter's earpiece. Finally, an additional step may be provided of using the compassing device to detect whether the firefighters procession along the target route is correct.

It is, therefore, an objective of the disclosed invention to provide a system and method for facilitating a more efficient way of locating and rescuing victims during a fire drill, without compromising safety.

In accordance with these and other objects which will become apparent hereinafter, the invention will now be described with particular reference to the drawing.

### BRIEF DESCRIPTION OF THE DRAWINGS

FIG. 1 shows an exemplary overview of a fire victim location and rescue system according to embodiments of the present invention.

### DETAILED DESCRIPTION

Referring now to the FIGURE, an exemplary overview of a fire victim location and rescue system according to embodiments of the present invention is shown. A firefighter 100 is shown outside the building 300 in which the fire drill will occur. Two routes (110 and 120) are shown leading to one or more victims 200. The direct route 110 is the shortest and fastest way to the victims, as calculated by the presently disclosed system. The indirect route 120 is the alternative safe route that is calculated in the event that the direct route is dangerous. The building 300, for the purposes of this invention, may be any building which may be occupied by people and would be susceptible to fire. It is envisioned, that the present invention would be configured with a building 300 and its inhabitants long before the fire drill is performed. This configuration would include the installation of smoke and temperature sensors throughout the most frequently traversed corridors and stairways throughout the building 300. As will be explained in greater detail below, the sensors will operate to assist the rescuing firefighter in the event of a fire drill at some future date.

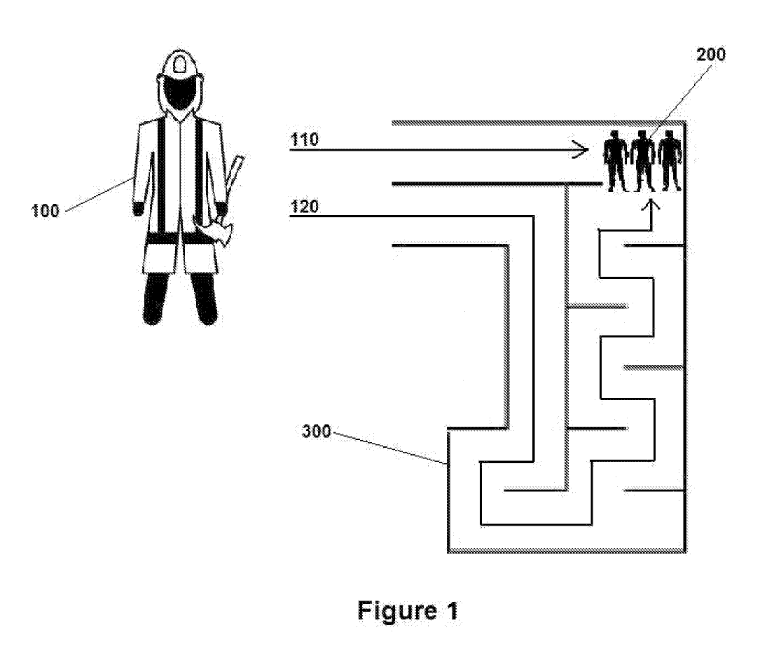

Referring still to FIG. 1, the firefighter 100, upon entering the building, will be equipped with a fire jacket according to embodiments of the present invention. The fire jacket has an associated fire goggle, communication device with earpiece, locator, compassing device, processor and memory. Thus, the fire jacket will require some means of power, such as, but not limited to a rechargeable lithium ion battery. The locator may be any device which utilizes global positioning system (herein “GPS”) technology to pinpoint specific latitude/longitude coordinates having an accuracy within a few feet. A locator is also equipped on a life saving device which is provided to one or more of a plurality of potential victims. The locator may be diminutive in size, but capable of broadcasting location to the rescuing firefighter. For example, the life saving device may be a small fob which attaches to a person's key chain or security credential in an office environment. This ensures that the security device will be on the potential victims person at all times.

The temperature and smoke sensors are disposed within a building wherein the fire drill is to be executed. There may be more than one of each so as to cover all of the important hallways and passages throughout the building. They are pre-installed in the building in which the fire drill will be ran. Their placement is strategic in that the sensors should be capable of determining the safety of certain main arteries throughout the building. Thus, if smoke and temperature sensors installed along the direct route 110 return feedback that dense smoke and higher than normal temperatures are present at a particular location, then an alternative route should be calculated. Decisions such as this are carried out by the processor. The processor is programmed with code to automatically determine the safest passage based on GPS data with regard to the position of the firefighter and the victim(s), as well as preconfigured threshold harmful levels of smoke and temperature. For example, suppose the preconfigured threshold for density of smoke is 100 parts per million (ppm). If the density measured by the smoke sensor is above 100 ppm in a certain corridor during a fire, the system will avoid that particular corridor in calculating a route.

Such data, such as threshold levels, may be stored in the memory. The memory may be any type of data storage medium, such as a hard drive or flash drive. The memory comprises instructions that cause the processor to execute a method. The method comprises the following the following steps. The first step involves detecting that a firefighter has put on the fire goggle, so that the fire drill is initiated. The second step involves detecting the location of a victim, wherein the detection is based on the life saving device that the victim is wearing. The next step involves determining a direct route between the firefighter and the victim. Then, an assessment is made as to whether the direct route is dangerous. The assessment is based on a number of factors. The factors include the average temperature and average amount of smoke along the direct route, as measured by the temperature and smoke sensors, respectively. If, based on the assessment, it is determined that the direct route is dangerous, then a safer indirect route is calculated in consideration of the average temperature and amount of smoke along the indirect route. For the purposes of this specification and claims, the route which is chosen to be the safest, regardless of whether it is the direct or indirect route, will be considered the target route.

Upon determining a target route, the firefighter is guided to advance along the route until the victim is reached. Upon reaching the victim, an assessment is made as to whether the direct exit route is dangerous. The assessment is based upon the same factors which were assessed with regard to the ingress route to find the victim. Once again, based on the assessment of average temperature and amount of smoke it is determined if the direct exit route is dangerous. If the direct exit route is found to be dangerous, an indirect route is calculated which takes into account the temperature and amount of smoke. Upon determination of the indirect route, the firefighter is guided along the target exit route.

In a further embodiment of the disclosed invention, the guiding of the firefighter along the target route entails periodically alerting the firefighter regarding distance and time until the victim and/or exit is reached. It also entails checking whether the current path being taken is correct, and alerts the firefighter as to the correct path if the current one is incorrect.

In still a further embodiment of the disclosed invention, the guiding involves digitally displaying the target route on the lens of firefighter's goggles. This may be carried out using a Heads-Up Display (“HUD”) component on the fire goggles. HUD systems are designed to digitally project an image on a transparent display, such as a goggles lens. Text and diagrams may be digitally projected on a HUD. In the present application, a diagram of the target route may be digitally displayed on the lens of the goggles. Furthermore, data regarding distance and direction may also be displayed. The alerting of the firefighter may be carried out via voice commands transmitted through the firefighter's earpiece. The voice commands may contain audio directions from the processor, similar to how a navigation system reads directions to a vehicle driver. Finally, an additional step may be provided of using the compassing device to detect whether the firefighters procession along the target route is correct. It is envision that such a compassing device would by synchronized with the processor and the locator such that the processor would recognize if the current compass direction matches the direction that the locator is suggesting.

In another embodiment of the disclosed technology, a method for helping a firefighter to identify dangerous areas, locations of victims, and routes of egress during a fire drill is provided. The method begins by providing a fire jacket to a firefighter. The fire jacket has an associated fire goggle, a communicator with earpiece, a locator and a compass. Next, a plurality of potential victims is provided a life saving device. Each life saving device has a locator. The locator may use GPS or some other wireless system to enable detection of location within a few feet. Next, one or more temperature and smoke sensors are installed throughout a building. The building to be the location where the fire drill will occur and where the victims are located. The method proceeds when the fire jacket is initiated or powered on upon detection that the jacket has been equipped or vested by the firefighter. Next, the location of the victim or victims is determined by detecting the locator of the victim's life saving device. Upon detection, a target route is calculated to the pinpointed location of the victim. The calculation of the target route takes into account data received from the temperature and smoke sensors in order to the calculate the safest, yet still the most direct route to the victim. Then, the firefighter is guided to the victim along the target route. Once the victim is discovered, an exit route is calculated. Once again, the calculation incorporates data from the temperature and smoke sensors in order to determine the shortest, least dangerous path to the exit along the exit route.

In further variations of this embodiment, the guiding of the firefighter along the target route entails periodically alerting the firefighter regarding distance and time until the victim and/or exit is reached. It also entails checking whether the current path being taken is correct, and alerts the firefighter as to the correct path if the current one is incorrect.

In still further variations of this embodiment, the guiding involves digitally displaying the target route on the lens of firefighter's goggles. Furthermore, the alerting of the firefighter may be carried out via voice commands transmitted through the firefighter's earpiece. Finally, an additional step may be provided of using the compassing device to detect whether the firefighters procession along the target route is correct.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A system for helping a firefighter to identify dangerous areas, locations of victims, and routes of egress during a fire drill, comprising:
a fire jacket;
a fire goggle attached to the fire jacket;
a communication device with an earpiece attached to the fire jacket;
a first locator attached to the fire jacket;
a compassing device attached to the fire jacket;
a temperature sensing device;
a smoke sensing device;
a life saving device associated with each of one or more victims, wherein the life saving device includes a second locator for locating each of the victims;
a processor associated with the fire jacket; and
memory associated with the fire jacket, the memory storing instructions to be executed by the processor, the instructions comprising a method, the method comprising the following steps:
detecting that a firefighter has put on the fire jacket and the fire goggle, so that the fire drill is initiated;
detecting the location of a victim, wherein the detection is based on the life saving device that the victim is wearing;
determining a direct route between the firefighter and the victim;
assessing whether the direct route is dangerous, wherein the assessment is based on:
average temperature of the direct route, as detected by the temperature sensing device that is installed at a point along the direct route; and
average amount of smoke along the direct route, as detected by the smoke sensing device that is installed at a point along the direct route;
if, based on the assessment, the direct route is dangerous:
calculating a safer indirect route in consideration of the average temperature and the average amount of smoke along the indirect route;
upon determining a target route, guiding the firefighter to advance along the target route until the victim is found;
after the victim is found by the firefighter:
determining a direct exit route between the firefighter and a designated exit;
assessing whether the direct exit route is dangerous, wherein the assessment is based on:
average temperature along the direct exit route, as detected by the temperature sensing device that is installed at a point along the direct exit route; and
average amount of smoke along the direct exit route, as detected by the temperature sensing device that is installed at a point along the direct exit route;
if, based on the assessment, the direct exit route is dangerous, calculating an indirect route in consideration of the average temperature and the average amount of smoke along the indirect exit route;
upon determining a target exit route, guiding the firefighter to advance along the target exit route.

2. The system of claim 1, wherein the guiding of the firefighter along the target route comprises:
periodically alerting the firefighter regarding remaining distance from the target victim;
periodically alerting the firefighter regarding how much time remains until the target victim is reached, based on current pace of the firefighter;
checking whether current path is correct with respect to the victim; and
alerting the firefighter with a correct path if the current path is incorrect.

3. The system of claim 2, wherein the guiding of the firefighter along the target exit route comprises:
periodically alerting the firefighter regarding remaining distance from the exit;
periodically alerting the firefighter regarding how much time remains until the exit victim is reached, based on current pace of the firefighter;
checking whether current path is correct with respect to the exit; and
alerting the firefighter with a correct path if the current path is incorrect.

4. The system of claim 3, wherein the guiding the firefighter to advance along the target route further comprises digitally displaying the target route to the firefighter on the lens of the fire goggle.

5. The system of claim 4, wherein the periodic alerting of the firefighter regarding distance and time to the target victim is carried out via the earpiece.

6. The system of claim 5, wherein the periodic alerting of the firefighter regarding distance and time to the exit is carried out via the earpiece.

7. The system of claim 6, wherein alerting of the firefighter of the correct path to the victim is carried out through both the lens display on the goggle and earpiece attached.

8. The system of claim 7, wherein alerting of the firefighter of the correct path to the exit is carried out through both the lens display on the goggle and earpiece attached.

9. The system of claim 8, further comprising a step of detecting whether the current path towards victim is correct using the compassing device during procession along target route.

10. The system of claim 9, further comprising a step of detecting whether the current path towards exit is correct using the compassing device during procession along target route.

11. A system for helping a firefighter to identify dangerous areas, locations of victims, and routes of egress during a fire drill, comprising:
a fire jacket;
a fire goggle attached to the fire jacket;
a communication device with an earpiece attached to the fire jacket;
a first locator attached to the fire jacket;
a compassing device attached to the fire jacket;
a temperature sensing device;
a smoke sensing device;
a life saving device associated with each of one or more victims, wherein the life saving device includes a second locator for locating each of the victims;
a processor associated with the fire jacket; and
memory associated with the fire jacket, which stores instructions to be executed by the processor, the instructions comprising:
detecting that a firefighter has put on the fire jacket and the fire goggle, so that the fire drill is being put into action;
detecting the location of a victim, wherein the detection is based on the life saving device that the victim is wearing;
determining a direct route between the firefighter and the victim;
assessing whether the direct route is dangerous, wherein the assessment is based on:
average temperature of the direct route, as detected by the temperature sensing device that is installed at a point along the direct route; and
average amount of smoke along the direct route, as detected by the temperature sensing device that is installed at a point along the direct route;
if, based on the assessment, the direct route is dangerous, calculating a safer indirect route in consideration of the average temperature and the average amount of smoke along the indirect route;
upon determining a target route, guiding the firefighter to advance along the target route until the victim is found;
during procession along target route:
periodically alerting the firefighter regarding remaining distance to the victim through the earpiece;
periodically alerting the firefighter through the earpiece regarding how much time remaining until reaching the victim, based on current pace of the firefighter;
detecting whether current direction towards victim is correct using the compassing device;
if the current direction is incorrect, alerting the firefighter with the correct direction, through both the goggle and the earpiece; and
after the victim is found by the firefighter:
determining a direct exit route between the firefighter and a designated exit to a safe area;
assessing whether the direct exit route is dangerous, wherein the assessment is based on:
average temperature along the direct exit route, as detected by the temperature sensing device that is installed at a point along the direct exit route; and
average amount of smoke along the direct exit route, as detected by the temperature sensing device that is installed at a point along the direct existing route;
if, based on the assessment, the direct exit route is dangerous, calculating a safer indirect route in consideration of the average temperature and the average amount of smoke along the indirect exit route;
upon determining a target exit route, guiding the firefighter to advance along the target exit route through the earpiece; and
during procession along target exit route:
periodically alerting the firefighter through the earpiece regarding remaining distance to the exit;
periodically alerting the firefighter through the earpiece regarding how much time remains before reaching the target exit, based on current pace of the firefighter;
detecting whether current path towards victim is correct using the compassing device; and
if the current direction is incorrect, alerting the firefighter with the correct direction, through the ear piece.

12. A method for helping a firefighter to identify dangerous areas, locations of victims, and routes of egress during a fire drill, comprising the following steps:
providing a fire jacket to a firefighter, said fire jacket comprising an associated fire goggle, a communicator with earpiece, a first locator and a compass;
providing each of a plurality of potential victims with a life saving device, said life saving device comprising a second locator;
installing one or more temperature and smoke sensors throughout a building;
initiating fire jacket upon detection that said jacket has been equipped on said firefighter;
determining, using said fire jacket, a location of a said victim by detecting said second locator of said life saving device of said victim;
calculating a target route to said location of said victim, said calculation incorporating data received from said temperature and smoke sensors to determine the shortest, least dangerous path to said victim;
guiding said firefighter to said victim along said target route;
upon discovering said victim, calculating an exit route to an exit, said calculation incorporating data received from said temperature and smoke sensors to determine the shortest, least dangerous path to said exit; and
guiding said firefighter to said exit along said exit route.

13. The system of claim 12, wherein said guiding of the firefighter along the target route comprises:
periodically alerting said firefighter regarding remaining distance to said victim;
periodically alerting said firefighter regarding how much time remains before reaching said target victim, based on current pace of said firefighter;
checking whether current path taken to said victim is correct; and
if the current direction is incorrect, alerting said firefighter with the correct direction; and
wherein said guiding of the firefighter along the target exit route comprises:
periodically alerting said firefighter regarding remaining distance to said exit;
periodically alerting said firefighter regarding how much time remains before reaching said exit, based on current pace of said firefighter;
checking whether current path taken to said exit is correct; and
if the current direction is incorrect, alerting said firefighter with the correct direction.

14. The system of claim 13, wherein said guiding of said firefighter along said target route and said exit route further comprises displaying a map to said firefighter using a Heads-Up-Display on a lens of said fire goggle.

15. The system of claim 14, wherein said periodic alerting of said firefighter regarding distance and time to said target victim and exit is carried out via said earpiece.

16. The system of claim 15, wherein said alerting of said firefighter of said correct direction to said victim and exit is carried out through both the lens display on said goggle and said earpiece.

17. The system of claim 16, wherein said step of checking whether the current path towards said victim is carried out by said compass.

18. The system of claim 17, wherein said step of checking whether the current path towards said exit is carried out by said compass.
